(19) United States
(12) Patent Application Publication
(10) Pub. No.: US 2013/0120101 A1
(43) Pub. Date: May 16, 2013

(54) FUSE BLOCK DEVICE

(71) Applicant: Naoto Taguchi, Makinohara-shi (JP)

(72) Inventor: Naoto Taguchi, Makinohara-shi (JP)

(73) Assignee: YAZAKI CORPORATION, Tokyo (JP)

(21) Appl. No.: 13/811,422

(22) PCT Filed: Jul. 21, 2011
(86) PCT No.: PCT/JP2011/066592

§ 371 Date: Jan. 22, 2013

(30) Foreign Application Priority Data
Jul. 23, 2010 (JP) 2010-166403

(51) Int. Cl. H01H 85/36

(52) U.S. Cl. CPC H01H 85/36
USPC 337/190

(57) ABSTRACT

Disclosed is a fuse block device that does not require total modification of a busbar even when circuits or ratings are changed. The fuse block device (50) comprises a busbar (10), a fuse block (20), and a fusible link with an electric wire (40). The fusible link with the electric wire (40) comprises a screw-tightened terminal (40T) that is screw-tightened with a bolt (B), a wire connection section (40W) connected to a wire (W), and a bulging section (40N) that houses a fuse element. A bolt insertion hole (10B) for inserting the bolt (B) is provided in the busbar (10), a nut (N) is embedded in the fuse block (20) on the rear side of the busbar (10), and an intermediate section (20N), that houses the bulging section (40N) and has the screw-tightened terminal (40T) in the fusible link with the electric wire (40) fixed by the bolt (B) to the busbar (10), is formed in the fuse block (20).

### TECHNICAL FIELD

The present invention relates to a fuse block device for mounting a large number of fuses which are connected between a battery and electrical equipment.

### BACKGROUND ART

A conventional fuse block device is known from PTL 1, for example.

### CITATION LIST

### Patent Literature

[PTL 1] JP-A-2004-127696

### Fuse Block Device Disclosed in PTL 1

A fuse block device disclosed in PTL 1 is a multi-type fusible link. As shown in an exploded perspective view of FIG. 6, a fusible link 100 includes a first fuse circuit structure 101 which is a busbar, a second fuse circuit structure 102 which is similarly a busbar, and a synthetic resin housing H in which these fuse circuit structures 101, 102 are mounted with a predetermined interval therebetween.

The first fuse circuit structure 101 is integrally formed by pressing a conductive planar plate material. The first fuse circuit structure 101 includes an elongated rectangular connection plate part, a plurality of female terminal parts 100T which are connected in a chain form along a transverse direction of the connection plate part via each fusible member part, and a plurality of screw-clamping terminal parts, etc. The second fuse circuit structure 102 has the same configuration as the first fuse circuit structure 101. Both fuse circuit structures are connected to each other by a common terminal part 103.

Although each fusible member part is hidden by the first fuse circuit structure 101 and not visible in FIG. 6 since each fusible member part is located between the first fuse circuit structure 101 and the second fuse circuit structure 102, the fusible member part has a narrow crank shape, as is well-known. Low melting point metals are crimped and fixed to the middle of the crank shape and each low melting point metal is melt and cut-off when current more than a predetermined value is applied thereto.

### SUMMARY OF INVENTION

### Technical Problem

### Defects in the Conventional Multi-Type Fusible Link

Since the conventional multi-type fusible link is configured as a multi-structure, a variety of fuses are integrally formed in the busbar. Accordingly, a pattern in which a large number of circuits are actually not used is provided due to the differences in grades or models of a vehicle. Further, only circuits less than half may be used in accordance with the models of the vehicle.

Further, design changes should be made to the integrally-formed busbar when circuits or ratings are changed and total modification of the busbar is required in accordance with change of the ratings and generation of free circuit for an integrated structure of the busbar. Consequently, the degree of freedom in designing a wire harness was reduced.

### Object of the Present Invention

The present invention is made to solve the above-described problems and an object of the present invention is to provide a fuse block device which is capable of eliminating waste due to the differences in the grades or the models of a vehicle by placing a fusible link with an electric wire only in the necessary circuits even when a pattern in which a large number of circuits are actually not used is provided due to the differences in the grades or the models of the vehicle and also which does not require total modification of a busbar even when circuits or ratings are changed.

### Solution to Problem

The above objects of the present invention are achieved by following configurations.

(1) A fuse block device comprising:

a busbar;

a fuse block, mounted to the busbar; and

a fusible link with an electric wire,

wherein a screw-tightened terminal to be screwed by a bolt is provided at one end of the fusible link with the electric wire, an electric wire connection part connected to the electric wire is provided at the other end of the fusible link, and a bulging part accommodating a fusible member is provided between the screw-tightened terminal and the electric wire connection part,

wherein the busbar is formed with a bolt insertion hole through which the bolt used in the screw-tightened terminal is inserted, and

wherein a nut is embedded in the fuse block on a rear side of the busbar and engaged with the bolt inserted through the bolt insertion hole, and an accommodation part accommodating the bulging part is formed at the fuse block in a state where the screw-tightened terminal of the fusible link with the electric wire is fixed to the busbar by the bolt.

(2) The fuse block device according to the configuration of the above (1),

wherein the fuse block device is formed separately from an electric junction box,

wherein the busbar includes a power feeding part receiving power from the electrical junction box and a plurality of the bolt insertion holes, and

wherein the fuse block includes a plurality of the accommodation parts.

According to the configuration of the above (1), it is possible to obtain a fuse block device which is capable of eliminating waste due to the differences in the grades or the models of a vehicle even when a pattern in which a large number of circuits are actually not used is caused due to the differences in the grades or the models of the vehicle and also which does not require total modification of a busbar even when circuits or ratings are changed.

Further, according to the configuration of the above (2), since the fuse block device is formed separately from the electric junction box, only the fuse block device can be independently designed and produced.

### BRIEF DESCRIPTION OF DRAWINGS

FIG. 1 is a perspective view of a fuse block device according to one embodiment of the present invention in a state where a FL (fusible link) mounting device and a fusible link are separated from each other, and an end thereof is shown in a longitudinal-sectional view through a bolt insertion hole.

FIG. 2 is a perspective view similar to FIG. 1 in a state where the FL mounting device and the fusible link are separated from each other, and an end thereof is shown in a longitudinal-sectional view shifted from the bolt insertion hole.

FIG. 3 is a perspective view showing a state where four fusible links with an electric wire are mounted to the FL mounting device shown in FIG. 1.

FIG. 4A is a perspective view of an electrical junction box in a state before the fuse block device shown in FIG. 3 is connected to a relay inner block and FIG. 4B is a perspective view of the electrical junction box in a state after the fuse block device is connected to the relay inner block.

FIGS. 5A to 5C are perspective views showing the electrical junction boxes in which the number of loads to be connected is different from each other.

FIG. 6 is an exploded perspective view of the fuse block device disclosed in PTL 1.

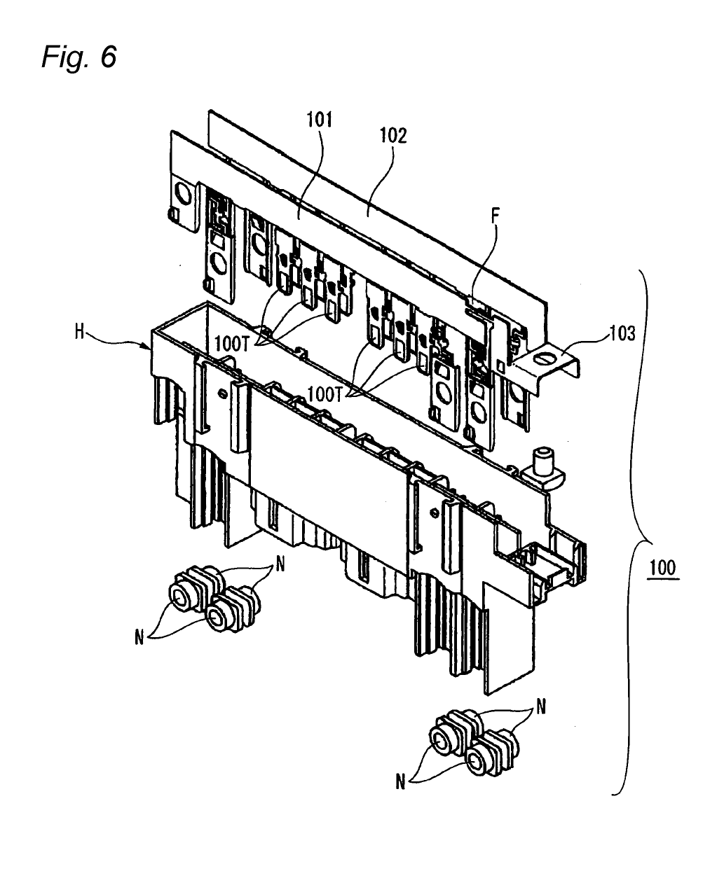

### DESCRIPTION OF EMBODIMENTS

### Fuse Block Device According to One Embodiment of the Present Invention

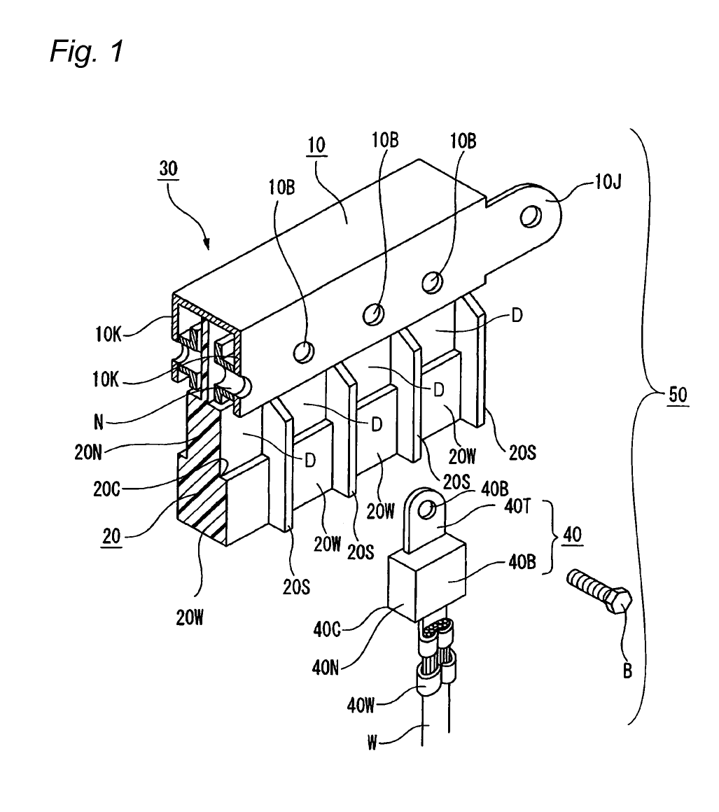

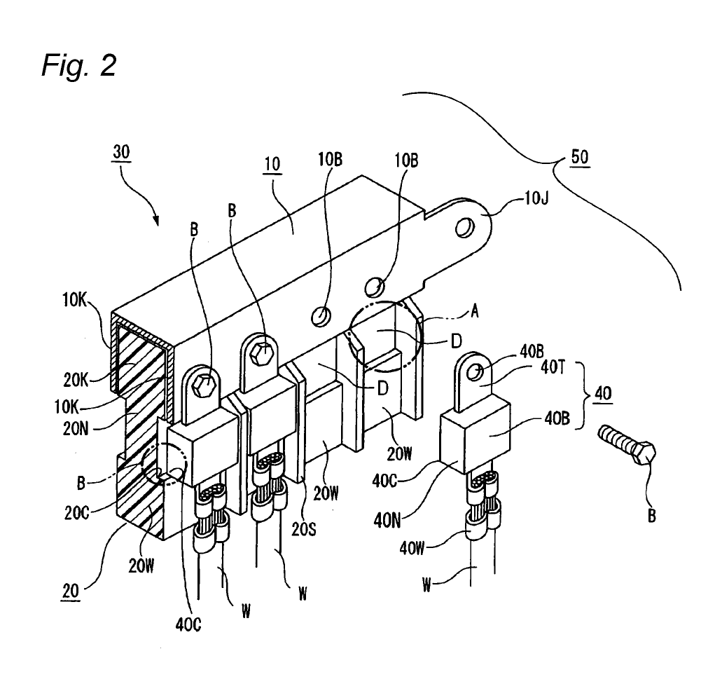

Hereinafter, a fuse block device according to one embodiment of the present invention will be described with reference to FIGS. 1 and 2. The fuse block device has no unused circuits even when there are differences in the grades or the models of a vehicle and also does not require total modification of a busbar even when circuits or ratings are changed.

### Structure of the Fuse Block Device 50

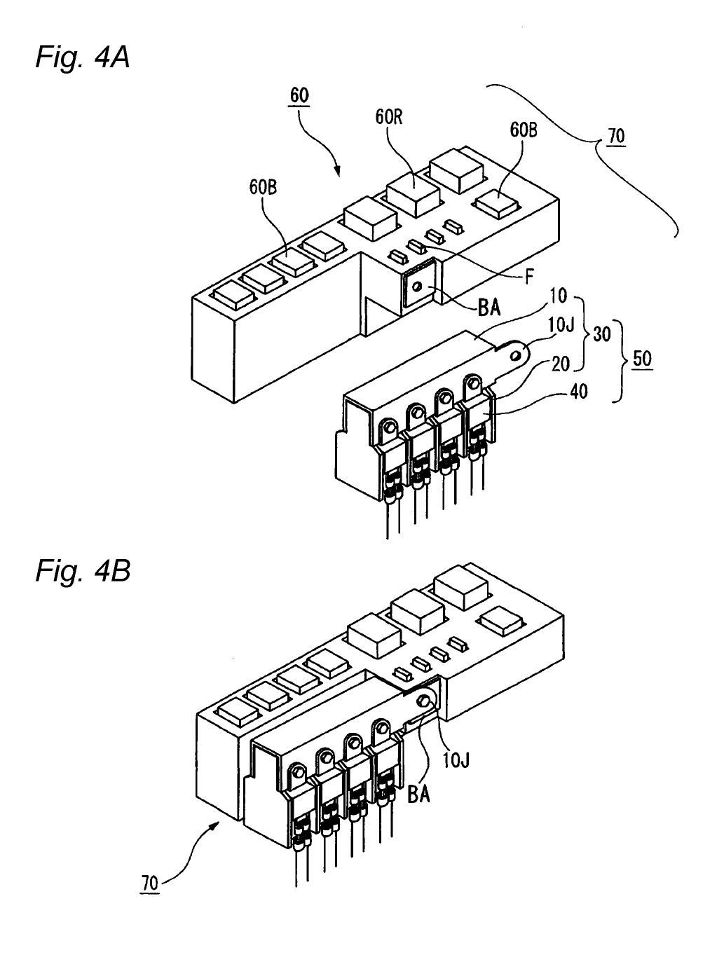

In FIGS. 1 and 2, any number of fusible links 40 with an electric wire can be mounted to a FL mounting device 30 which includes a busbar 10 and a fuse block 20 mounted to the busbar 10. As the fusible link 40 with the electric wire is mounted to the FL mounting device 30, a fuse block device 50 (FIG. 4) is completed. That is, the fuse block device 50 according to the present embodiment is composed of the FL mounting device 30 which includes the busbar 10 and the fuse block 20 mounted to the busbar 10 and the fusible link 40 with the electric wire.

### Structure of Busbar 10

The busbar 10 is formed by pressing an elongated conductive metal plate in a U-shape cross-section. A plurality of bolt insertion holes 10B are opened at a predetermined interval in a longitudinal direction of an open leg part 10K having a U-shape cross-section and a terminal part 10J is formed at an end of the elongated conductive metal plate. An end of the fuse block 20 is mounted between both open leg parts 10K having the U-shape cross-section

### Structure of the Fuse Block 20

A thickness of the fuse block 20 is set so that: an upper part 20K (see, FIG. 2), which is a rear portion of the open leg part 10K of the busbar 10, has a wider thickness; and a lower part 20W has a wider thickness similarly to the upper part 20K, as seen from a longitudinal sectional view. A thickness of an intermediate part 20N between the upper part and the lower part is narrower than that of the upper part 20K and the lower part 20W. A length of the intermediate part 20N in a vertical direction is the same as a vertical length of a rectangular resin-molded bulging part 40N of the fusible link 40 with the electric wire. Further, a width (thickness) of the intermediate part 20N in a lateral direction is dimensioned so that a predetermined lateral length of the rectangular bulging part 40N of the fusible link 40 with the electric wire is accommodated in an area which is formed by the difference between the width of the lower part 20W and the width of the intermediate part 20N. Accordingly, as a whole, as indicted by circle A of two-dot chain line in FIG. 2, a concave (accommodation part) D can be formed to accommodate one side of the rectangular resin-molded bulging part 40N of the fusible link 40 with the electric wire.

Further, a corner 20C (a part indicated by circle B of two-dot chain line in FIG. 2) is formed at a corner of the concave D of the fuse block 20 and a corner 40C is formed at a corner of the rectangular bulging part 40N of the fusible link 40 with the electric wire. Accordingly, the corner 40C of the fusible link 40 with the electric wire is caught in the corner 20C of the fuse block 20.

Then, a nut N (see, FIG. 1) is embedded in the upper part 20K (see, FIG. 2) of the fuse block 20 and engaged with the bolt B inserted through the bolt insertion hole 10B.

### Structure of the Fusible Link 40 with the Electric Wire

The fusible link 40 with the electric wire includes a screw-tightened terminal 40T at one end thereof, an electric wire connection part 40W at the other end thereof and the bulging part 40N at an intermediate portion thereof. The screw-tightened terminal 40T has a screw hole 40B screwed by the bolt B (see, FIG. 1). The electric wire connection part 40W is connected to the electric wire W by crimping an electric wire W (see, FIG. 1) and then performing a spot-welding or an ultrasonic-connection. The bulging part 40N is adapted to accommodate a fusible member therein. The bulging part 40N is formed into a rectangular parallelepiped shape by injection molding of resin and a lower corner of the bulging part which faces the fuse block 20 is formed as a corner (edge) shape 40C.

Each of the electric wires W connected to the electric wire connection part 40W is coupled to the respective load.

### Mounting of the Fusible Link 40 with the Electric Wire

Mounting of the fusible link 40 with the electric wire to the FL mounting device 30 is carried out as follows. The bolt B is inserted through the screw hole 40B of the screw-tightened terminal 40T of the fusible link 40 with the electric wire and then inserted through the bolt insertion hole 10B of the busbar 10, so that the bolt is screwed. Then, the bolt B is screwed into the nut N (see, FIG. 1) embedded in the upper part 20K (see, FIG. 2) of the fuse block 20 and therefore the fusible link 40 with the electric wire is fixed to the busbar 10. In this state, the bulging part 40N of the fusible link 40 with the electric wire is partially accommodated in the concave D which is the intermediate part 20N of the fuse block 20, so that the bulging part 40N is stably fixed to the fuse block 20. In this instance, since the corner 40C of the rectangular parallelepiped bulging part 40N of the fusible link 40 with the electric wire is caught in the corner 20C of the intermediate part 20N of the fuse block 20, the fusible link 40 with the electric wire can be more stably mounted to the FL mounting device 30.

Since the busbar 10 is formed with a plurality of bolt insertion holes 10B (in FIG. 1, a total of eight bolt insertion holes are provided, four thereof are provided at a front leg part of U-shaped leg part of the busbar 10 and four thereof are provided at an opposite side of the front leg part), the fusible link 40 with the electric wire can mounted up to eight, thereby obtaining a multi-structure.

### Any Number of Fusible Links 40 with the Electric Wire can be Mounted

FIG. 2 shows a state where two fusible links 40 with the electric wire are mounted to the FL mounting device 30. As described above, since a plurality of bolt insertion holes 10B is formed through the busbar 10 according to the present embodiment, it is possible to obtain the multi-structure in which the fusible link 40 with the electric wire can mounted up to eight.

In a case where a pattern in which a large number of circuits are actually not used is caused due to the differences in the grades or the models of the vehicle, the fusible links 40 with the electric wire should be mounted to the bolt insertion holes 10B of the busbar 10 connected to the unused circuits. Further, according to the present embodiment, total modification of the busbar is not required even when circuits or ratings are changed and it is only required to mount the fusible links 40 with the electric wire to the bolt insertion holes 10B connected to the required circuits.

### A role of a Conventional Multi FL can be Replaced

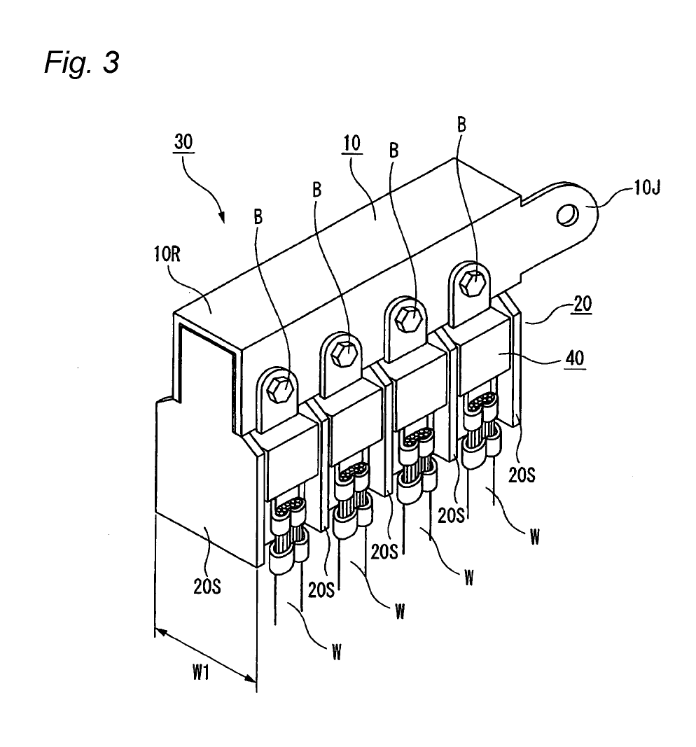

FIG. 3 shows a state where four fusible links 40 with the electric wire are mounted to the FL mounting device 30. An insulation partition plate 20S is provided at an area of the FL mounting device 30 between the fusible links 40 with the electric wire or at the ends of the fusible links 40 with the electric wire, so that the fusible links 40 with the electric wire are insulated from each other.

The same number of poles can be provided at a space equivalent to a conventional multi FL by making a lateral width W1 of the insulation partition plate 20S equal to that of the conventional multi FL. Accordingly, the insulation partition plate 20S can replace a role of the conventional multi FL.

### Other Effects

Since the fuse block 20 is provided with a space for accommodating the fusible link 40 with the electric wire, this space serves to prevent the element part from being damaged by an external tension transmitted from the electric wire W to the fusible link 40.

### Fuse Block Device can be Fixed to a Single Relay Inner Block

An electrical junction box 70 according to the present embodiment includes a relay inner block 60 shown in FIG. 4A and the fuse block device 50 shown in FIG. 3. The relay inner block 60 is equipped at its interior with an electronic control unit of relays 60R which are connected to an external load via fusible links 60B and fuses F. Symbol BA of FIG. 4A represents an inner block busbar for fastening the busbar of the fuse block. As the terminal part 10J of the busbar 10 of the fuse block device 50 according to the present embodiment is connected to the inner block busbar BA as shown in FIG. 4B, all of the loads connected to the fuse block device 50 according to the present embodiment can be electrically connected to the relay inner block 60 via the fuses F.

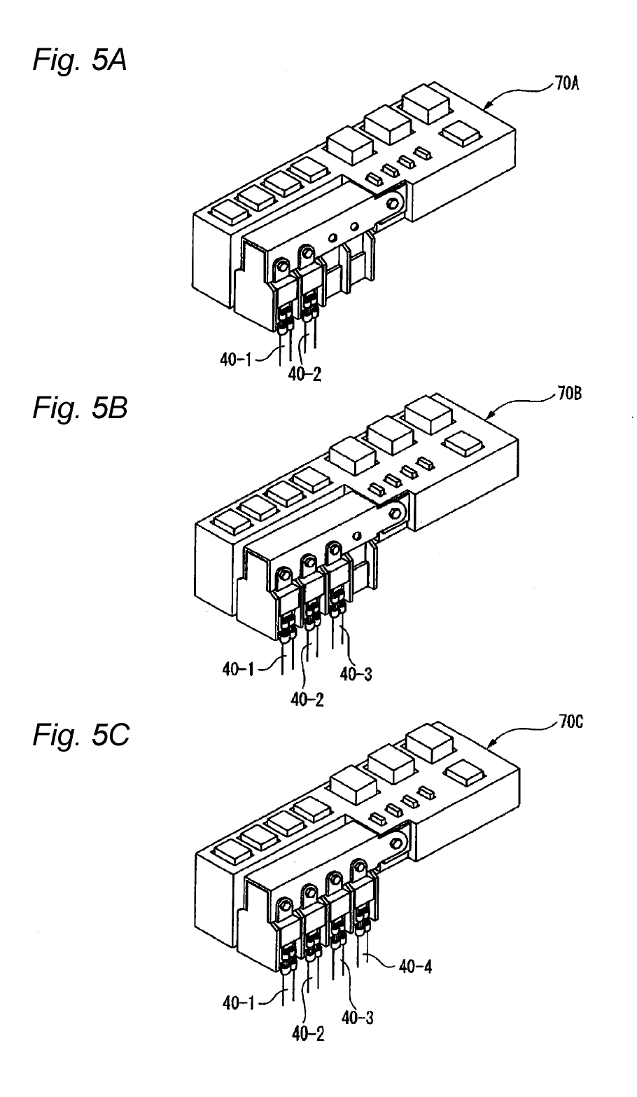

FIGS. 5A to 5C are perspective views for explaining that unused fusible links are not generated by employing the fuse block device 50 of the present embodiment even when the number of loads to be connected to the electrical junction box is different from each other.

FIG. 5A shows an electrical junction box 70A to which two loads are connected. In this case, only two fusible links 40-1 and 40-2 with the electric wire according to the present embodiment are used and thus unused fusible links are not generated.

FIG. 5B shows an electrical junction box 70B to which three loads are connected. In this case, only three fusible links 40-1. 40-2 and 40-3 with the electric wire according to the present embodiment are used and thus unused fusible links are not generated.

FIG. 5C shows an electrical junction box 70C to which four loads are connected. In this case, only four fusible links 40-1, 40-2, 40-3 and 40-4 with the electric wire according to the present embodiment are used and thus unused fusible links are not generated.

In a similar way, the fusible link with the electric wire can be used up to eight and thus unused fusible links are not generated.

Since a total of eight fuses are mounted to a conventional electrical junction box, unused fuses are generated and thus waste occurs. However, according to the present embodiment, the fusible links 40-1 to 40-8 with the electric wire can be freely mounted up to eight. Accordingly, a required number of fusible links can be mounted and thus there occurs no waste of the fusible links.

Although eight fusible links have been described as an example in the above description, this specific number is given for the convenience of description and the present invention is not limited to such a specific number.

Further, it should be understood that the above embodiments are illustratively presented as a typical embodiment of the present invention and the present invention is not limited to the above embodiments. That is, the present invention can be variously realized in a range without departing from the gist of the present invention.

This application is based upon Japanese Patent Application No. 2010-166403 filed on Jul. 23, 2010 and the contents of which are incorporated herein by way of reference.

### INDUSTRIAL APPLICABILITY

According to the fuse block device of the present invention, it is possible to obtain a fuse block device which is capable of eliminating waste due to the differences in the grades or the models of a vehicle even when a pattern in which a large number of circuits are actually not used is caused due to the differences in the grades or the models of the vehicle and also which does not require total modification of a busbar even when circuits or ratings are changed.

### REFERENCE SIGNS LIST

10 Busbar
10B Bolt insertion hole
10J Terminal part (Power feeding part)
10K Open leg part
20 Fuse block
20C Corner (edge) of concave
20K Upper part
20N Intermediate part
20S insulation partition plate
20W Lower part
30 FL mounting device
40 Fusible link with electric wire
40B Screw hole
40C Corner (Edge) of bulging part
40N Bulging part
40T Screw-tightened terminal
40W Electric wire connection part
50 Fuse block device
60 Relay inner block
60R inner relay
60B Inner fusible link
70 Electrical junction box
B Bolt
D Concave (Accommodation part)
F Inner fuse
N Nut
W Electric wire

1. A fuse block device comprising:
a busbar;
a fuse block, mounted to the busbar; and
a fusible link with an electric wire,
wherein a screw-tightened terminal to be screwed by a bolt is provided at one end of the fusible link with the electric wire, an electric wire connection part connected to the electric wire is provided at the other end of the fusible link, and a bulging part accommodating a fusible member is provided between the screw-tightened terminal and the electric wire connection part,
wherein the busbar is formed with a bolt insertion hole through which the bolt used in the screw-tightened terminal is inserted, and
wherein a nut is embedded in the fuse block on a rear side of the busbar and engaged with the bolt inserted through the bolt insertion hole, and an accommodation part accommodating the bulging part is formed at the fuse block in a state where the screw-tightened terminal of the fusible link with the electric wire is fixed to the busbar by the bolt.

2. The fuse block device according to claim 1,
wherein the fuse block device is formed separately from an electric junction box,
wherein the busbar includes a power feeding part receiving power from the electrical junction box and a plurality of the bolt insertion holes, and
wherein the fuse block includes a plurality of the accommodation parts.
